(19) United States
(12) Patent Application Publication
(10) Pub. No.: US 2008/0191971 A1
(43) Pub. Date: Aug. 14, 2008

(54) PLASMA DISPLAY AND DRIVING METHOD THEREOF

(76) Inventors: Seung-Min Kim, Suwon-si (KR); Woo-Joon Chung, Suwon-si (KR); Seung-Won Choi, Suwon-si (KR); Tae-Seong Kim, Suwon-si (KR); Jun-Ho Lee, Suwon-si (KR)

Correspondence Address: CHRISTIE, PARKER & HALE, LLP, PO BOX 7068, PASADENA, CA, 91109-7068, US

(21) Appl. No.: 11/967,752

(22) Filed: Dec. 31, 2007

(30) Foreign Application Priority Data
Feb. 13, 2007 (KR) 10-2007-0014927

(51) Int. Cl. G09G 3/28

(52) U.S. Cl. 345/60

(57) ABSTRACT

In a plasma display device and a driving method thereof, a switch for applying a voltage rising waveform to a scan electrode during an idle period and a first period is coupled between the scan electrode and a power source. The switch applies the voltage rising waveform having a first slope by being repeatedly turned on/off according to a first control signal during the idle period, and/or the switch applies the voltage rising waveform having a second slope (having a higher gradient than the first slope) by being repeatedly turned on/off according to a second control signal during the first period. As such, the scan electrode voltage is increased with the first slope during the idle period to perform a more stable reset operation. Also, when the idle period does not exist, the voltage of the scan electrode is increased within the first period to enable a normal reset operation.

### CROSS-REFERENCE TO RELATED APPLICATION

This application claims priority to and the benefit of Korean Patent Application No. 10-2007-0014927 filed in the Korean Intellectual Property Office on Feb. 13, 2007, the entire content of which is incorporated herein by reference.

### BACKGROUND OF THE INVENTION

1. Field of the Invention

The present invention relates to a plasma display device that can efficiently use an idle period, and a driving method thereof.

2. Description of the Related Art

A plasma display device is a flat panel display that uses plasma generated by a gas discharge to display characters or images. Depending on its size, the plasma display device can include a plasma display panel (PDP) having tens to millions of discharge cells that are arranged in a matrix format.

Generally, in a plasma display device, one frame is driven by dividing the frame into a plurality of subfields, each having a weight (or a weight of a grayscale). In this case, luminance of a discharge cell is determined by summing the weights of the subfields. In addition, each subfield includes a reset period, an address period, and a sustain period. The reset period is for initializing a wall charge state of each discharge cell, and the address period is for performing an addressing operation so as to select light emitting cells (or cell to be turned on). The sustain period is for displaying an image by sustain-discharging the light emitting cells selected in the address period for a period that corresponds to a weight of the corresponding subfield.

In addition, the plasma display device includes an idle period between frames. Since an external video signal is not input with precise timing each time, the idle period is provided between frames to provide a safety margin for the video signal. A conventional plasma display device does not apply a driving waveform during the idle period. That is, the idle period is not utilized for driving of the plasma display device.

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of embodiments of the present invention are directed to a plasma display device that efficiently utilized an idle period to drive the plasma display device, and a driving method thereof.

A plasma display device according to an embodiment of the present invention includes an electrode (e.g., a scan electrode) and a switch. The switch is coupled between a first power source that supplies a first voltage and the electrode, and increases a voltage of the electrode during an idle period. A first control signal is repeatedly changed to a high level and a low level with a first cycle, and the switch increases the voltage of the electrode with a first slope by being repeatedly turned on and turned off according to the first control signal during the idle period.

A plasma display device according to another embodiment of the present invention includes a switch and a switch driving circuit. The switch is coupled between an electrode and a first power source that supplies a first voltage to gradually increase a voltage of the first electrode with a first slope by repeating a turn-on operation and a turn-off operation with a first cycle during an idle period. The switch driving circuit receives a first control signal during the idle period and applies either a second voltage or a third voltage that is lower in voltage level than the second voltage to a control end of the switch corresponding to the first control signal.

A method according to an embodiment of the present invention drives a plasma display device having a switch coupled between an electrode and a first power source that supplies a first voltage to gradually increase a voltage of the electrode. The method includes, in an idle period, increasing the voltage of the electrode with a first slope by repeatedly turning on and turning off the switch according to a first control signal, and in a part of a reset period, increasing the voltage of the first electrode with a second slope by repeatedly turning on and turning off the switch according to a second control signal. The first slope has s lower gradient than that of the second slope.

### BRIEF DESCRIPTION OF THE DRAWINGS

FIG. 1 shows a plasma display device according to an exemplary embodiment of the present invention.

FIG. 2 shows a driving waveform of a plasma display device according to a first exemplary embodiment of the present invention.

FIG. 3 shows a driving waveform of a plasma display device according to a second exemplary embodiment of the present invention.

FIG. 4 shows a driving waveform of a plasma display device according to a third exemplary embodiment of the present invention.

FIG. 5 schematically shows a scan electrode driver according to the first to third exemplary embodiments of the present invention.

FIG. 6 shows a data driving circuit of a switch Yrr according to the first to third exemplary embodiments of the present invention.

FIG. 7 shows a first control signal Din1 according to the first and second exemplary embodiments of the present invention.

FIG. 8 shows a second control signal Din2 according to the second and third exemplary embodiments of the present invention.

FIG. 9 shows a current path formed in a gate driving circuit of FIG. 6 when the first control signal is at a high level according to the exemplary embodiments of the present invention.

FIG. 10 shows a current path formed in a scan electrode driver of FIG. 6 according to the first to third exemplary embodiments of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the another element or “electrically coupled” to the another element through a third element. In addition, unless explicitly described to the contrary, the word “comprise” and variations such as “comprises” or “comprising” will be understood to imply the inclusion of stated elements but not the exclusion of any other elements.

A plasma display device and a driving method thereof according to an exemplary embodiment of the present invention will now be described in more detail with reference to the accompanying drawings.

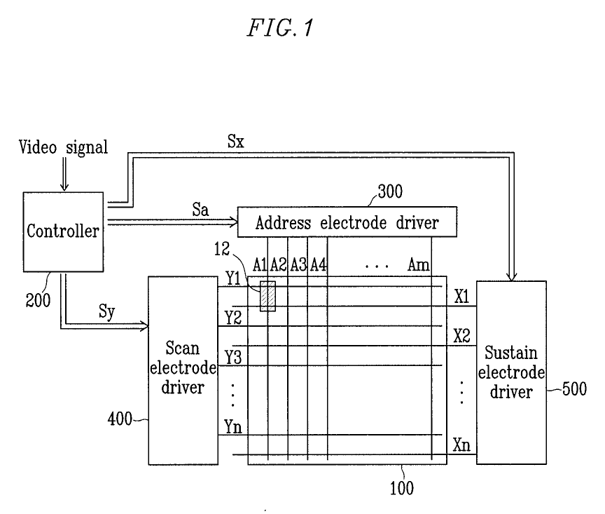

FIG. 1 shows a plasma display device according to an exemplary embodiment of the present invention.

As shown in FIG. 1, the plasma display device according to the exemplary embodiment of the present invention includes a plasma display panel (PDP) 100, a controller 200, an address electrode driver 300, a scan electrode driver 400, and a sustain electrode driver 500. The PDP 100 includes a plurality of address electrodes A1 to Am extending in a column direction, and a plurality of sustain electrodes Xn to Xn and a plurality of scan electrodes Y1 to Yn extending in a row direction. Hereinafter, the address electrodes will be referred to as “A electrodes”, the sustain electrodes will be referred to as “X electrodes”, and the scan electrodes will be referred to as “Y electrodes”. The plurality of Y electrodes Y1 to Yn and X electrodes X1 to Xn are arranged as pairs. Discharge cells 12 are formed at crossing regions of the A electrodes A1 to Am with the X and Y electrodes X1 to Xn and Y1 to Yn.

The controller 200 externally receives video signals and outputs an A electrode driving control signal Sa, an X electrode driving control signal Sx, and a Y electrode driving control signal Sy. In addition, the controller 200 controls the plasma display by dividing one frame into a plurality of subfields, each having a weight, and an idle period is provided between frames.

The address electrode driver 300 receives an A electrode driving control signal from the controller 200 and applies a signal for selecting the discharge cells to be turned on to the respective A electrodes A1 to Am. The sustain electrode driver 500 receives an X electrode driving control signal Sx from the controller 200 and applies a driving voltage to the respective X electrodes X1 to Xn, and the scan electrode driver 400 receives a Y electrode driving control signal Sy from the controller 200 and applies a driving voltage to the respective Y electrodes Y1 to Yn.

A driving waveform of a plasma display device according to an exemplary embodiment of the present invention will now be described in more detail.

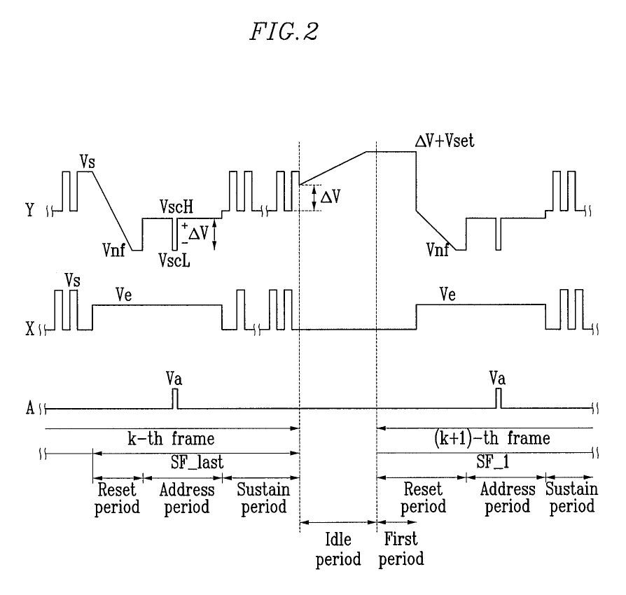

FIG. 2 shows a driving waveform of a plasma display device according to a first exemplary embodiment of the present invention. According to the first exemplary embodiment of the present invention, an idle period is included between frames by utilizing input timing of a video signal. For better understanding and ease of description, a driving waveform applied to a Y electrode, an X electrode, and an A electrode for forming one discharge cell will be described below.

As shown in FIG. 2, the driving waveform includes an idle period between the k-th frame and a (k+1)-th frame. Each frame is formed of a plurality of subfields, and each subfield includes a reset period, an address period, and a sustain period. For convenience of description, FIG. 2 shows a driving waveform applied to the last subfield SF_last of the k-th frame, an idle period, and the first subfield SF_1 of the (k+1)-th frame for convenience of description.

As shown in the driving waveform applied to the last subfield SF_last of the k-th frame, a Vs voltage is applied to the Y electrode while a reference voltage (0V in FIG. 2) is applied to the A and X electrodes during a reset period. Hereinafter, the reference voltage will be set to 0V. The voltage of the Y electrode is gradually decreased from the Vs voltage to a Vnf voltage by a driving waveform applied to the Y electrode while the A electrode is maintained at 0V and the X electrode is applied with a bias voltage (Ve voltage in FIG. 2). Hereinafter, the bias voltage will be set to the Ve voltage. Here in FIG. 2, when a reset waveform is applied between subfields in a manner like the above, discharge cells that are sustain discharged in a sustain period of a previous subfield are reset discharged and thus all discharge cells are reset. The present invention, however, is not limited by the waveform of FIG. 2. That is, another waveform that can reset discharge cells that have been sustain discharged in the sustain period of the previous subfield may be used as a reset waveform of the reset period between subfields.

In the address period, a scan voltage (VscL voltage in FIG. 2) is sequentially applied to the plurality of Y electrodes while the Ve voltage is applied to the X electrodes so as to select discharge cells to be turned on. Hereinafter, the scan voltage will be set to the VscL voltage. In this case, an address voltage (Va voltage in FIG. 2) is applied to an A electrode that extends to discharge cells to be selected from among a plurality of discharge cells formed by the Y electrodes being applied with the VscL voltage. Then, an address discharge is generated between an A electrode applied with a Va voltage and the Y electrode applied with the VscL voltage, and between the Y electrode applied with the VscL voltage and the X electrode applied with the Ve voltage so that positive (+) wall charges are formed on the Y electrode and negative (−) wall charges are formed on the A and X electrodes. In this case, the VscL voltage may be set to be less than or equal to the Vnf voltage. A non-scan voltage (VscH voltage in FIG. 2) is applied to at least one Y electrode to which the VscL voltage is not applied, and 0V is applied to an A electrode of a non-selected discharge cell. In this case, a voltage difference between the VscH voltage and the VscL voltage is set to ΔV.

In the sustain period, a sustain voltage (Vs voltage in FIG. 2) and 0V are applied to the Y and X electrodes so that a sustain discharge is generated between the Y and X electrode. Herein, the sustain voltage has a reverse phase of 0V. That is, a process of applying 0V to the X electrode while the Vs voltage is applied to the Y electrode and a process of applying the Vs voltage to the X electrode while the 0V voltage is applied to the Y electrode are repeated a number of times to correspond to a weight of the corresponding subfield.

An idle period starts from the end of the k-th frame and ends at the beginning of the (k+1)-th frame. During the idle period, a switch that applies a voltage to the Y electrode is repeatedly turned on and turned off according to a first control signal. Hereinafter, a driving waveform according to a switch control will be described in more detail with reference to FIG. 2. Variations of the driving waveform according to the switch control will be described later in more detail with reference to FIGS. 5 to 10.

In the idle period, a voltage waveform rising from a ΔV voltage to a ΔV+Vset voltage with a predetermined slope (that may be predetermined) is applied to the Y electrode while 0V is applied to the A and X electrodes. Here, the slope corresponds to a slope that will increase the voltage of the Y electrode during the idle period, and will be referred to as a first slope. In this case, the first slope is irrelevant to the length of a first period. FIG. 2 shows that the voltage of the Y electrodes increases from the ΔV voltage with the first slope and reaches the ΔV+Vset voltage during the idle period. Therefore, during the idle period, the voltage of the Y electrode is increased from the ΔV voltage to the ΔV+Vset voltage with the first slope and maintained at the ΔV+Vset voltage while 0V is applied to the A and X electrodes. In this case, the first slope has a lower gradient (or is less steep) than a slope with which the voltage of the Y electrode is increased from the ΔV voltage to the ΔV+Vset voltage in the case that the idle period does not exist.

When the (k+1)-th frame is started, a driving waveform is applied to the first subfield SF_1 of the (k+1)-th frame. The first subfield SF_1 is formed of a reset period, an address period, and a sustain period, and the first period starts from the (k+1)-th frame and ends at a time point that the voltage of the Y electrode is decreased in the reset period. The switch that applies a voltage to the Y electrode is repeatedly turned on and turned off according to the first control signal during the first period. During the first period, the voltage of the Y electrode is maintained at the ΔV+Vset voltage while 0V is applied to the A and X electrodes. In this case, the ΔV+Vset voltage is high enough to generate a discharge in all the discharge cells.

During the idle period and the first period, the voltage of the Y electrode is increased from the ΔV voltage to the ΔV+Vset voltage with the first slope and is then maintained at the ΔV+Vset voltage. A voltage difference between the Y and X electrode and between the Y and A electrodes becomes greater than a discharge starting voltage (hereinafter will be referred to as a discharge firing voltage) so that a weak discharge is generated between the Y and X electrodes and between the Y and A electrodes in the idle period and the first period. Due to the weak discharge, negative (−) wall charges are formed on the Y electrode and positive (+) wall charges are formed on the X and A electrodes.

After the first period in the reset period, a voltage waveform that gradually decreases the voltage of the Y electrode from 0V to the Vnf voltage is applied to the Y electrode while 0V is applied to the A electrode and the Ve voltage is applied to the X electrode. As described, while the falling waveform is applied to the Y electrode, a weak discharge is generated between the Y electrode and the A electrode so that the negative wall charges formed on the Y electrode and the positive wall charges formed on the X and A electrodes are erased. In general, the size of a (Vnf-Ve) voltage is set close to a discharge firing voltage Vfxy between the Y electrode and the X electrode. Then, a wall voltage between the Y electrode and the X electrode wall voltage becomes close to 0V so that a discharge cell that has not experienced an address discharge in the address period is prevented (or protected) from being mis-operated.

Subsequently, the address period and the sustain period occur. Here, a driving waveform applied in the address period and the sustain period of the first subfield of the (k+1)-th frame is the same (or substantially the same) as the driving waveform applied in the address period and the sustain period of the k-th frame, and therefore further description will not be provided.

As described above, the voltage of the Y electrode is increased with the first slope during the idle period according to the first exemplary embodiment of the present invention. In addition, the voltage of the Y electrode is increased from the ΔV voltage to the ΔV+Vset voltage with a slope that is steeper than the first slope when the idle period does not exist. When the voltage of the Y electrode is increased with the first slope in the idle period, wall charges are formed for a relatively longer period of time than resetting the status of the discharge cells by increasing the voltage of the Y electrode during the reset period. Therefore, a rising slope of the voltage of the Y electrode can be decreased, thereby performing a more stable reset operation by applying the voltage rising waveform to the Y electrode during the idle period.

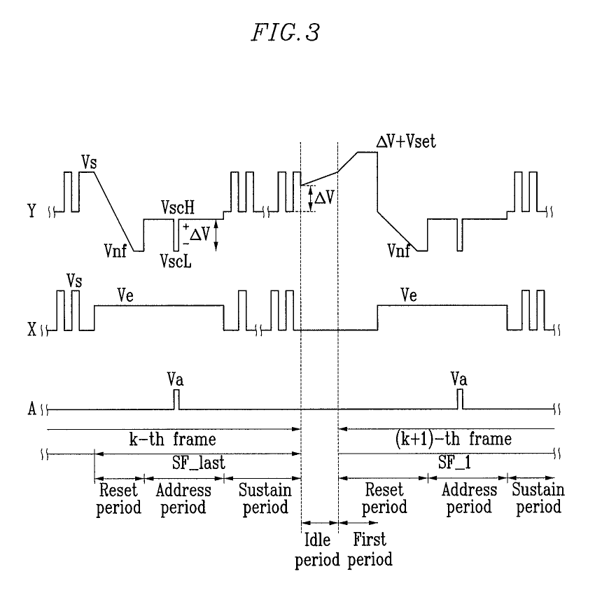

FIG. 3 shows a driving waveform of the plasma display device according to a second exemplary embodiment of the present invention. The second exemplary embodiment of the present invention includes an idle period that is shorter than the idle period of the first exemplary embodiment of the present invention. As shown in FIG. 3, the driving waveform according to the second exemplary embodiment of the present invention includes the idle period between the k-th frame and the (k+1)-th frame. In addition, each subfield includes a reset period, an address period, and a sustain period, and the second embodiment is similar to the first embodiment except for operations in the idle period and the first period.

During the idle period, a switch that applies a voltage to the Y electrode is repeatedly turned on and turned off according to a first control signal (e.g., the first control signal as described above with respect to the first embodiment), and a voltage waveform that increases a voltage of the Y electrode from the ΔV voltage with a first slope (e.g., the first slope as described above with respect to the first embodiment) is applied to the Y electrode while 0V is applied to the A and X electrodes. In this case, the first slope is irrelevant to the length of the idle period. As shown in FIG. 3, the voltage of the Y electrode is increased from the ΔV voltage with the first slope, and the idle period ends before the voltage of the Y electrode is increased to the ΔV+Vset voltage. Therefore, the voltage of the Y electrode is increased with the first slope during the idle period, and the voltage of the Y electrode at the end of the idle period is determined in proportion to the length of the idle period.

Hereinafter, the first period refers to a period during which the switch that applies a voltage to the Y electrode is repeatedly turned on and turned off according to a second control signal. In the first period, the voltage of the Y electrode is increased from a voltage level of the Y electrode at the end of the idle period to the ΔV+Vset voltage with a second slope, and is then maintained at the ΔV+Vset voltage. Herein, the second slope has a higher gradient (or is steeper) than the first slope, and the voltage of the Y electrode can be increased from the ΔV voltage to the ΔV+Vset voltage with the second slope in the first period in case that the idle period does not exist.

As described above, the voltage of the Y electrode is increased to the ΔV voltage with the first slope during the idle period, but the idle period according to the second exemplary embodiment of the present invention is not long enough for the voltage of the Y electrode to be increased to the ΔV+Vset voltage. However, the voltage of the Y electrode is increased from the ΔV voltage with the first slope during the idle period and increased from the voltage level at the end of the idle period to the ΔV+Vset voltage with the second slope during the first period according to the second exemplary embodiment of the present invention. Therefore, the voltage of the Y electrode rises with the first and second slopes during the idle period and the first period so that the voltage of the Y electrode can reach the ΔV+Vset voltage at the end of the first period, regardless of the length of the idle period.

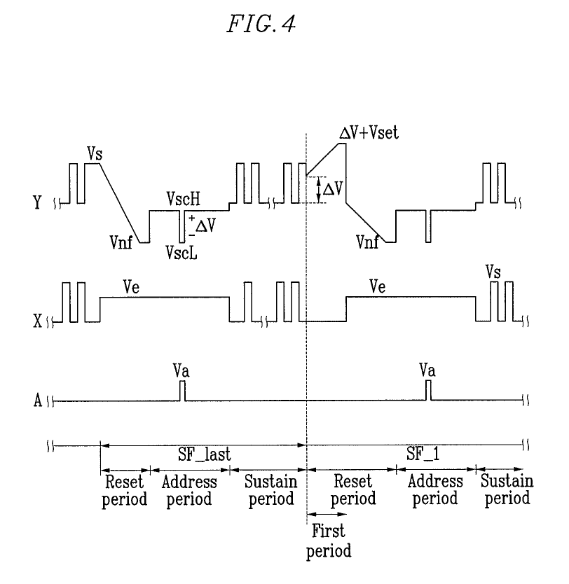

FIG. 4 shows a driving waveform of the plasma display device according to a third exemplary embodiment of the present invention. The third exemplary embodiment of the present invention does not include an idle period. The third exemplary embodiment is similar to the first and second exemplary embodiments, except that the idle period is not included and a driving waveform of a first period is not the same as those of the first and second exemplary embodiments.

A switch that applies a voltage to the Y electrode is repeatedly turned on and turned off according to a second control signal (e.g., the second control signal as described above with respect to the second embodiment) during a first period. The first period starts from the start of the reset period of the (k+1)-th frame and ends at a time point when the voltage of the Y electrode falls.

During the first period, a voltage waveform that increases the voltage of the Y electrode from the ΔV voltage to the ΔV+Vset voltage with a second slope (e.g., the second slope as described above with respect to the second embodiment) is applied to the Y electrode while 0V is applied to the A and X electrodes. In this case, the second slope is a slope with which the voltage of the Y electrode can increase from the ΔV voltage to the ΔV+Vset voltage during the first period. That is, the voltage of the Y electrode can be increased from the ΔV voltage to the ΔV+Vset voltage with the second slope within the first period. Therefore, the voltage of the Y electrode can reach the ΔV+Vset voltage so that all discharge cells can be reset regardless of the existence of the idle period.

The voltage of the Y electrode is controlled by turning the switch on/off during the idle period and the first period according to the first to third exemplary embodiments of the present invention. However, when a voltage rising waveform is applied to a typical plasma display device, a rising waveform is applied by a voltage charged to a capacitor while the switch is maintained in the turn-on state. Also, applying a voltage rising waveform of a reset period to an idle period may cause problems. That is, when an idle period is provided and the idle period is long enough that the voltage of the Y electrode can reach a voltage that is high enough to reset all discharge cells, a normal reset function can be performed. As such, when the idle period does not exist or when the voltage of the Y electrode cannot be increased high enough to reset all the discharge cells during the idle period, the normal reset operation cannot be performed since the voltage of the Y electrode cannot increase high enough for resetting discharge cells by the capacitor. Therefore, when the idle period is provided, the voltage rising waveform should be applied by turning on/off of the switch so as to perform the normal reset operation. That is, the normal reset operation can be performed even though the idle period does not exist by controlling the turning on/off of the switch.

According to the first to third exemplary embodiments of the present invention, when the voltage of the Y electrode can be increased from the ΔV voltage to the ΔV+Vset voltage with the first slope within the idle period, the voltage of the Y electrode is maintained at the ΔV+Vset voltage after being increased during the idle period. Therefore, the rising slope of the voltage of the Y electrode can be set to be less steep so that a more stable reset operation can be performed.

When the idle period ends before the voltage of the Y electrode that has been increased from the ΔV voltage with the first slope reaches the ΔV+Vset voltage, the voltage of the Y electrode is increased with either the first slope or the second slope during the idle period and the first period and reaches the ΔV+Vset voltage at the end of the first period.

In addition, when the idle period does not exist, the voltage of the Y electrode is increased from the ΔV voltage with the second slope and reaches the ΔV+Vset voltage during the first period. Therefore, the voltage of the Y electrode can be increased to the ΔV+Vset voltage for resetting all the discharge cells regardless of the existence of the idle period according to the first to third exemplary embodiments of the present invention.

The scan electrode driver 400 that generates the Y electrode driving waveform shows in FIGS. 2 to 4 will now be described in more detail.

FIG. 5 shows a driving circuit of the scan electrode driver 400 according to the first to third exemplary embodiments of the present invention. The switch is provided as an N-channel field effect transistor (FET) having a body diode, but the present invention is not thereby limited. That is, the switch can be replaced with another switch that has the same or similar functions of the N-channel FET. In addition, a capacitive component formed by the X and Y electrodes is illustrated as a panel capacitor Cp in FIG. 5.

As shown in FIG. 5, the scan electrode driver 400 includes a sustain driver 410, a reset driver 420, and a scan driver 430.

The sustain driver 410 includes a power recovery unit 411 and switches Ysr and Yg. The sustain driver 410 alternately applies the Vs voltage and 0V to the Y electrodes during the sustain period.

The power recovery unit 411 includes a power recovering capacitor, a power recovering inductor, a switch for forming a rising path, and a switch for forming a falling path. The power recovering capacitor is changed by a voltage (e.g., Vs/2 voltage) between the Vs voltage and 0V voltage. When either the switch for forming the rising path or the switch for forming the falling path is turned off, an LC resonance current path is formed between the power recovering capacitor, the power recovering inductor, and the panel capacitor Cp so that a voltage of the panel capacitor Cp is increased or decreased.

The switch Ysr is coupled between a Vs power source that supplies the Vs voltage and a Y electrode, and the switch Yg is coupled between a GND power source that supplies 0V and the Y electrode. When the switch Ysr is turned on during the sustain period, the Vs voltage is applied to the Y electrode, and when the switch Yg is turned on, 0V is applied to the Y electrode.

The reset driver 420 includes switches Yrr, Ynp, and Yfr and a zener diode ZDf. The reset driver 420 applies a rising waveform or a waveform that increases a voltage to a level (that may be predetermined) and then maintains the voltage at the level during the idle period and the first period, and applies a reset falling waveform to the Y electrode during the reset period.

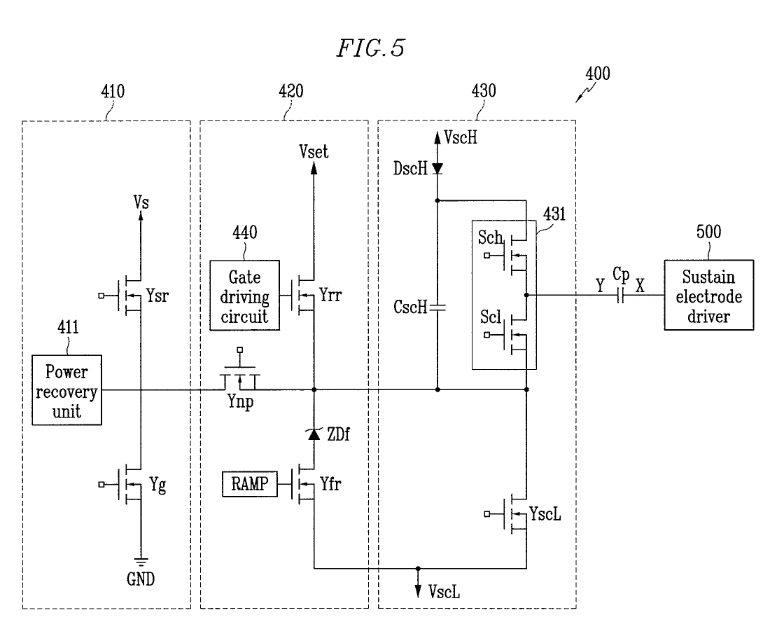

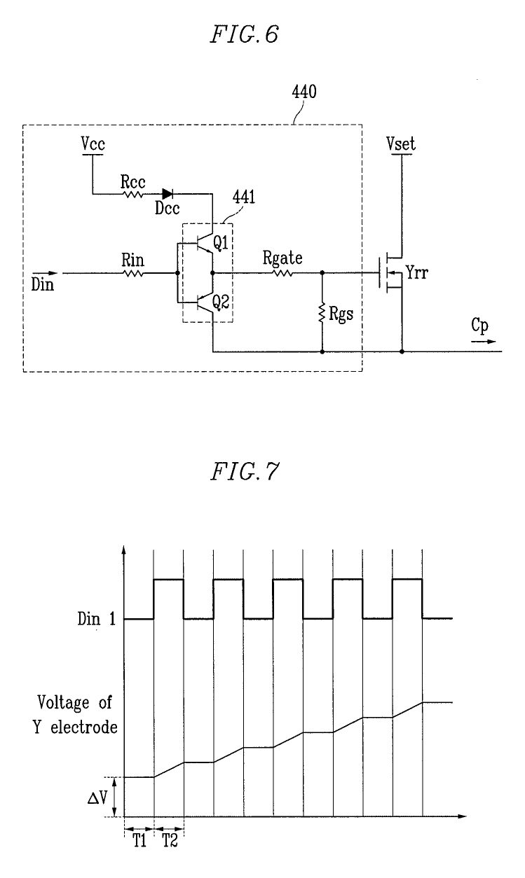

A gate driving circuit 440 of the switch Yrr controls the switch Yrr to be turned on/off according to the first control signal during the idle period. The switch Yrr is turned on/off according to the first control signal during the idle period, and the voltage of the Y electrode is increased with the first slope by the operation of the switch Yrr. In addition, the gate driving circuit 440 of the switch Yrr controls the switch Yrr to be turned on/off according to the second control signal during the first period. The switch Yrr is turned on/off according to the second control signal during the first period, and the voltage of the Y electrode is increased with the second slope by the operation of the switch Yrr. The operation and voltage application of the switch Yrr according to the first and second control signals will be described in more detail with reference to FIGS. 6 to 9.

The switch Yfr is coupled between a VscL power source that supplies the VscL voltage and the Y electrode, and the zener diode ZDf is coupled between the switch Yfr and the Y electrode. That is, an anode of the zener diode ZDf is coupled to the switch Yfr, and a cathode of the zener diode ZDf is coupled to the Y electrode. A cathode voltage of the zener doped ZDf is gradually decreased to the Vnf voltage from the VscL voltage by the turn-on operation of the switch Yfr in a falling period of the reset period. The Vnf voltage corresponds to a breakdown voltage of the zener diode ZDf.

A source of the switch Ynp is coupled to the cathode of the zener diode ZDf, and a drain of the switch Ynp is coupled to the sustain driver 410. In addition, the switch Ynp is turned off while the Y electrode is applied with a voltage that is lower than the 0V voltage so that a current path from the GND power source to the Y electrode is blocked (or prevented) from being formed.

The scan driver 430 includes a selection circuit 431, a diode DscH, a capacitor CscH, and a switch YscL. The scan driver 430 sequentially applies the VscL voltage to the plurality of Y electrodes Y1 to Yn, and applies the VscH voltage to Y electrodes that are not applied with the VscL voltage.

The selection circuit 431 includes switches Sch and Scl. The switch Sch is coupled between a VscH power source that supplies the VscH voltage and the Y electrode, and the switch Scl is coupled between the VscL power source and the Y electrode. Although one selection circuit 431 coupled to one Y electrode is illustrated in FIG. 5, the plurality of Y electrodes may be respectively coupled with the corresponding selection circuit, and a plurality selection circuits may be coupled with each other, forming an integrated circuit IC.

An anode of the diode DscH is coupled to the VscH power source, and a cathode of the diode DscH is coupled to the switch Sch. The diode DscH forms a current path from the VscH power source to the Y electrode when the switch Sch is turned on, and blocks (or prevents) the VscH power source from being over-charged by blocking (or preventing) a current from flowing to the VscH power.

A first end of the switch YscL is coupled to the VscL power source, and a second end of the switch YscL is coupled to the switch Scl of the selection circuit 431. The capacitor CscH is coupled between the VscH power source and the VscL power source. That is, the first end of the capacitor CscH is coupled to a node of the diode DscH and the switch Sch, and the second end of the capacitor CscH is coupled to a node of the switch YscL and the switch Scl. Therefore, the capacitor CscH is coupled in series between the VscH power source and the VscL power source. Here, the capacitor CscH turns on the switch YscL at the early driving stage of the plasma display device so as to be charged with the ΔV voltage that corresponds to a voltage difference between the VscH voltage and the VscL voltage.

The gate driving circuit 440 will now be described in more detail. The gate driving circuit 440 is coupled to a gate of the switch Yrr, and applies a voltage rising waveform to the Y electrode by controlling the switch Yrr during the idle period and the first period.

FIG. 6 shows the gate driving circuit 440 of the switch Yrr according to the first to third exemplary embodiments of the present invention.

As shown in FIG. 6, the gate driving circuit 440 of the switch Yrr includes a push-pull circuit 441, resistors Rcc, Rgate, Rin, and Rgs, and a diode Dcc. The push-pull circuit 441 is formed of an npn-type transistor Q1 and a pnp-type transistor Q2. An emitter of the respective transistors Q1 and Q2 is coupled to a gate of the switch Yrr through the resistor Rgate, and a collector of the transistor Q2 is coupled to a source of the switch Yrr. A collector of the transistor Q1 is coupled to a cathode of the diode Dcc, and an anode of the diode Dcc is coupled to a Vcc power source through the resistor Rcc. In addition, a base of the respective transistors Q1 and Q2 receives a control signal Din through the resistor Rin. The resistor Rgs is coupled between the gate and source of the switch Yrr.

The transistor Q1 is turned on and the transistor Q2 is turned off or the transistor Q1 is turned off and the transistor Q2 is turned on according to the control signal Din applied to the bases of the transistor Q1 and the transistor Q2. In this case, when the transistor Q1 is turned on, a high-level voltage applied to the collector of the transistor Q1 is applied to the gate of the switch Yrr. When the transistor Q2 is turned on, a low-level voltage applied to the collector of the transistor Q2 is applied to the gate of the switch Yrr.

The resistor Rin is utilized to determine the size of a current flowing to the bases of the transistors Q1 and Q2 when the control signal Din is applied, and the resistor Rgate is utilized to determine the size of a current flowing to the gate of the switch Yrr. The resistor Rgs prevents a gate voltage of the switch Yrr from being suddenly changed due to a source voltage of the switch Yrr to thereby block (or prevent) a mis-operation of the switch Yrr. In addition, when a source voltage of the switch Yrr is higher than a voltage supplied from the Vcc power source, the diode Dcc blocks a current path to the Vcc power source.

FIG. 7 shows a first control signal Din1 according to the first and second exemplary embodiments of the present invention.

The first control signal Din1 of a low level is applied to the push-pull circuit 441 for a first time T1, and then the first control signal Din of a high level is applied to the push-pull circuit 441 for a second time T2. Then, a process of turning off the switch Yrr due to the first control signal Din1 of the high level and a process of turning on the switch Yrr due to the first control signal Din1 of the low level are repeated.

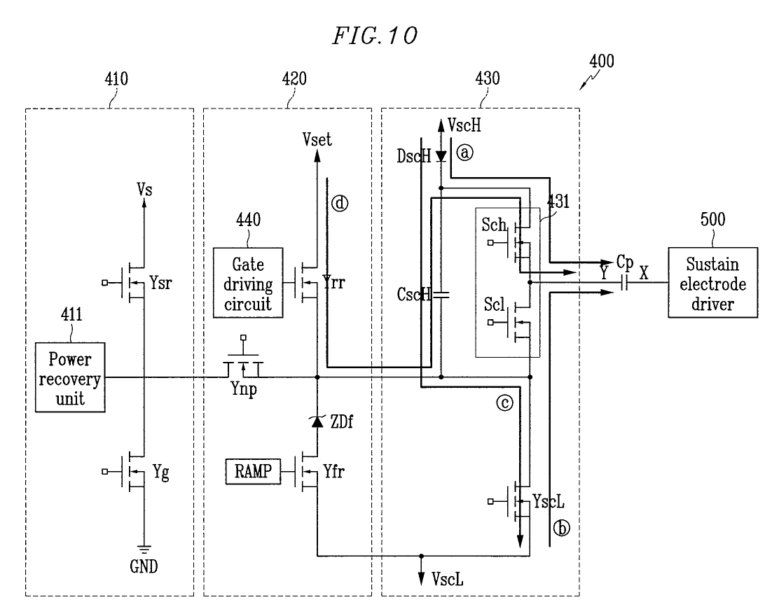

Referring to FIG. 9, when the first control signal Din1 of the high level is applied to the push-pull circuit 441, the transistor Q1 is turned on and the transistor Q2 is turned off. Then, a current path \textcircled{1} is formed from the Vcc power source through the resistor Rcc, the diode Dcc, and the transistor Q1 to the resistor Rgate. A voltage charge to a parasitic capacitor Cgs between the gate and the source of the switch Yrr becomes greater than a threshold voltage V_{T} due to a current flowing through the current path \textcircled{1}. The capacitor Cgs is charged with the voltage that is higher than the threshold voltage V_{T} due to the current flowing through the current path \textcircled{1} so that the switch Yrr is turned on. When the switch Yrr is turned on, a current path \textcircled{2} is formed from the Vset power source through the switch Yrr. A voltage variation of the Y electrode in the case that the current path \textcircled{2} is formed will now be described in more detail with reference to FIG. 10.

FIG. 10 shows a current path formed in the scan electrode driver 400 of the FIG. 5 according to the first to third exemplary embodiments of the present invention.

The capacitor CscH is charged with a voltage (that may be predetermined) by a voltage applied to the Y electrode during the address period. The switch is turned on while the VscH voltage is applied to the Y electrode during the address period. Then, a current path \textcircled{a} is formed from the VscH power source through the diode DscH and the switch Sch to the panel capacitor Cp. Then, the VscH voltage is applied to the Y electrode through the current path \textcircled{a}. During the address period, the switches YscL and Scl are turned on while the VscL voltage is applied to the Y electrode. Then, a current path \textcircled{b} is formed from the VscL power source through the switch YscL and the switch Scl to the panel capacitor Cp. Then, the VscL voltage is applied to the Y electrode through the current path \textcircled{b}. In this case, due to the switch YscL being in the turn-on state, a charging path \textcircled{c} is formed from the VscH power source through the diode DscH, the capacitor CscH, and the switch YscL to the VscL power source by the switch YscL, and the capacitor CscH is charged with the ΔV voltage that corresponds to a difference between the VscH voltage and the VscL voltage.

Subsequently, the switch Yrr and the switch Sch are turned on in the idle period. Then, a current path \textcircled{d} is formed from the Vset power source through the switch Yrr, the diode CscH, and the switch Sch to the panel capacitor Cp. When the current path \textcircled{d} is formed, the voltage of the Y electrode is increased from the ΔV voltage with the first slope by repetition of the process of turning on/off the switch Yrr in accordance with the first control signal Din1 and the voltage charged to the capacitor DscH. FIG. 7 shows the voltage of the Y electrode, increasing from the ΔV voltage with the first slope according to the first control signal Din1. The first control signal Din1 of the high level is repeatedly applied to the push-pull circuit 441 during the second time T2 after the first control signal Din1 of the low level is applied to the push-pull circuit 441 during the first time T1. Then, the process of turning on the switch Yrr by the first control signal Din1 of the high level and the process of turning off the switch Yrr by the first control signal Din1 of the low level are repeated. Accordingly, the voltage of the Y electrode is increased when the switch Yrr is in the turn-on state, is then stabilized when the switch Yrr is in the turn-off state, and then the voltage of the Y electrode is increased again when the switch Yrr is in the turn-on state. Through repetition of the above process, the voltage of the Y electrode is increased with a constant slope. This slope is determined by a ratio of the first time T1 during which the first control signal Din1 of the low level is applied and the second time T2 during which the first control signal Din1 of the high level is applied. By such a switching operation, the voltage of the Y electrode is gradually increased from the ΔV voltage with the first slope, and when the voltage of the Y electrode reaches the ΔV+Vset voltage, the voltage of the Y electrode is maintained at the ΔV+Vset voltage.

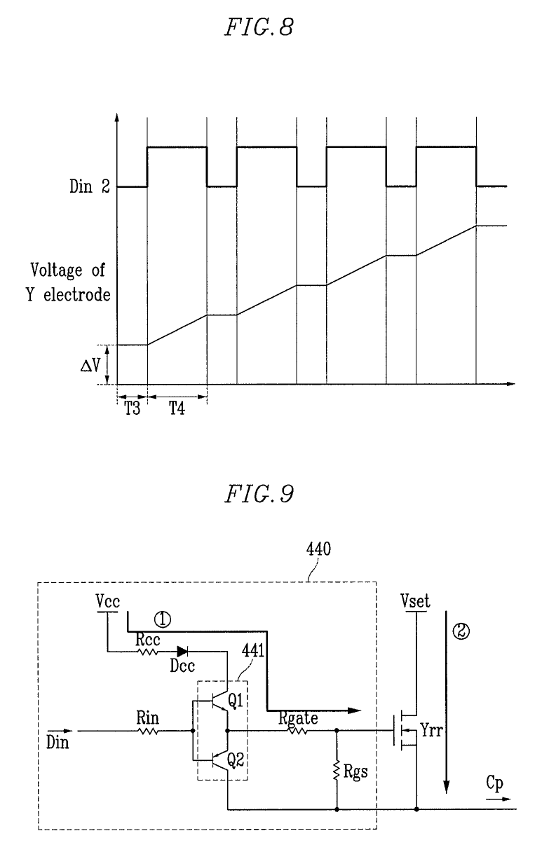

FIG. 8 shows a second control signal Din2 applied to the gate driving circuit 440 of FIG. 6 according to the second and third exemplary embodiments of the present invention. The second control signal Din2 of a low level is applied to the push-pull circuit 441 during a third time T3, and then the second control signal Din2 of a high level is applied to the push-pull circuit 441 during a fourth time T4. This process is repeated during the first period. Then, the switch Yrr is repeatedly turned on and turned off by the second control signal Din2 of the high level and the second control signal Din2 of the low level. Driving of the gate driving circuit 440 according to the second control signal Din2 is the same (or substantially the same) as the voltage rising driving of the Y electrode according to the first control signal Din1 shown in FIG. 10.

However, the second control signal Din2 of the high level is applied for a relatively longer period of time than the first control signal Din1 of the high level. Therefore, a slope with which the voltage of the Y electrode is gradually increased becomes steeper when the second control signal Din2 is applied than when the first control signal Din1 is applied. Accordingly, the voltage of the Y electrode can reach the ΔV+Vset voltage faster by the second control signal Din2 than by the first control signal Din1, and the voltage of the Y electrode is maintained at the ΔV+Vset voltage after reaching the ΔV+Vset voltage.

As described above, the voltage of the Y electrode is increased by turning on/off of the switch during the idle period and the first period according to the first to third exemplary embodiments of the present invention. The voltage of the Y electrode is increased with the first slope by turning on/off of the switch Yrr according to the first control signal Din1 during the idle period and is increased with the second slope by turning on/off of the switch Yrr according to the second control signal Din2 during the first period, and the voltage of the Y electrode is maintained at the ΔV+Vset voltage after the voltage reaches the ΔV+Vset voltage. Accordingly, the voltage of the Y electrode is increased with the first slope when the idle period exists so that wall charges can be more stably accumulated by the relatively less steep slope, and when the idle period does not exist, the voltage of the Y electrode is increased with the second slope by the second control signal Din2 so that the voltage of the Y electrode can be increased to a voltage level that is sufficient for a reset operation, thereby enabling a normal reset operation.

According to the exemplary embodiments of the present invention, a plasma display device that can efficiently use an idle period and a driving method thereof can be provided.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display device comprising:
an electrode; and
a switch coupled between a first power source for supplying a first voltage and the electrode to increase a voltage of the electrode during an idle period,
wherein a first control signal is repeatedly changed to a high level and a low level with a first cycle, and
wherein the switch increases the voltage of the electrode with a first slope by being repeatedly turned on and turned off according to the first control signal during the idle period.

2. The plasma display device of claim 1, wherein, in a first period following the idle period,
a second control signal is repeatedly changed to a high level and a low level with a second cycle, and
the switch increases the voltage of the electrode with a second slope by being repeatedly turned on and turned off during the first period according to the second control signal.

3. The plasma display device of claim 2, wherein the first period is a part of a reset period of a frame and is driven following the idle period, and the second slope has a higher gradient than the first slope.

4. The plasma display device of claim 3, wherein the switch increases the voltage of the electrode from a second voltage to a third voltage during the idle period and increases the voltage of the electrode from a third voltage to a fourth voltage during the first period, and a difference between the fourth voltage and the second voltage is substantially equal to the first voltage.

5. The plasma display device of claim 4, further comprising a switch driving circuit for turning the switch on/off,
wherein the switch driving circuit comprises:
a first transistor having a collector coupled to a second power source for supplying a fifth voltage, an emitter coupled to a control end of the switch, and a base for receiving either the first control signal or the second control signal; and
a second transistor having an emitter coupled to the control end of the switch, a collector coupled to a third voltage source for supplying a sixth voltage lower in voltage level than the fifth voltage, and a base for receiving either the first control signal or the second control signal.

6. The plasma display device of claim 5, wherein the switch driving circuit further comprises:
a first resistor between the emitter of the first transistor and the control end of the switch;
a second resistor between the second power source and the collector of the first transistor; and
a diode having an anode coupled to the second resistor and a cathode coupled to the collector of the first transistor.

7. The plasma display device of claim 6, wherein the switch driving circuit further comprises a third resistor between the control end of the switch and the electrode.

8. The plasma display device of claim 6, wherein the electrode is a scan electrode.

9. The plasma display device of claim 6, wherein the electrode comprises a plurality of scan electrodes.

10. A plasma display device comprising:
a switch coupled between an electrode and a first power source for supplying a first voltage to gradually increase a voltage of the electrode with a first slope by repeating a turn-on operation and a turn-off operation with a first cycle during an idle period; and
a switch driving circuit for receiving a first control signal during the idle period, and for applying either a second voltage or a third voltage lower in voltage level than the second voltage to a control end of the switch in accordance with the first control signal.

11. The plasma display device of claim 10, wherein, in a first period being a part of a reset period and following the idle period,
the switch driving circuit receives a second control signal, and applies either the second voltage or the third voltage to the control end of the switch in accordance with the second control signal, and
the switch increases the voltage of the electrode with a second slope by repeating the turn-on operation and the turn-off operation with a second cycle.

12. The plasma display device of claim 11, wherein the second slope has a higher gradient than the first slope.

13. The plasma display device of claim 12, wherein the electrode is a scan electrode.

14. The plasma display device of claim 12, wherein the electrode comprises a plurality of scan electrodes.

15. A method for driving a plasma display device having a switch coupled between an electrode and a first power source for supplying a first voltage to gradually increase a voltage of the electrode, the method comprising:
in an idle period, increasing the voltage of the electrode with a first slope by repeatedly turning on and turning off the switch according to a first control signal; and
in a part of a reset period, increasing the voltage of the first electrode with a second slope by repeatedly turning on and turning off the switch according to a second control signal,
wherein the first slope has a lower gradient than the second slope.

16. The method of claim 15, wherein, the part of the reset period starts at the beginning of a first subfield of a frame and ends before the voltage of the electrode is decreased in the reset period of the first subfield of the frame.

17. The method of claim 16, wherein the switch is turned on by a first current path passing through a first transistor coupled between a second power source for supplying a second voltage for turning on the switch and a control end of the switch, and wherein the switch is turned off by a second current path passing through a second transistor coupled between the electrode and the control end of the switch.

18. The method of claim 17, wherein the first current path further passes through a diode having an anode coupled to the second power source through a first resistor and a cathode coupled to a first end of the first transistor.

19. The method of claim 18, wherein the first current path further passes through a second resistor coupled between a second end of the first transistor and the control end of the switch.

20. The method of claim 18, wherein the electrode is a scan electrode.
